(19) United States
(12) Patent Application Publication
(10) Pub. No.: US 2025/0322557 A1
(43) Pub. Date: Oct. 16, 2025

(54) STYLE KITS GENERATION AND CUSTOMIZATION

(71) Applicant: ADOBE INC., SAN JOSE, CA (US)

(72) Inventors: Kelly Hurlburt, Brooklyn, NY (US); Brooke Hopper, Berkeley, CA (US); Minh-Anh Vuong, Ottawa (CA); Tidjane Tall, Toronto (CA)

(21) Appl. No.: 18/958,842

(22) Filed: Nov. 25, 2024

Related U.S. Application Data
(60) Provisional application No. 63/632,827, filed on Apr. 11, 2024.

(51) Int. Cl. G06T 11/00

(52) U.S. Cl. CPC G06T 11/00; G06T 2200/24

(57) ABSTRACT

A method, apparatus, non-transitory computer readable medium, and system for image processing include obtaining a style kit including a first image generation input indicating a first image attribute, a second image generation input indicating a second image attribute, and a selectability parameter indicating that the second image generation input is selectable. A third image generation input is received from a user based on the selectability parameter, wherein the third image generation input indicates a third image attribute different from the second image attribute of the second image generation input. An image generation model generates a synthetic image based on the style kit, the first image generation input, and the third image generation input, wherein the synthetic image has the first image attribute and the third image attribute.

### CROSS-REFERENCE TO RELATED APPLICATION

This application claims benefit under 35 U.S.C. § 119 to U.S. Provisional Application No. 63/632,827, filed on Apr. 11, 2024, in the United States Patent and Trademark Office, the disclosure of which is incorporated by reference herein in its entirety.

### BACKGROUND

The following relates generally to image processing, and more specifically to image generation using machine learning. Digital image processing refers to the use of a computer to edit a digital image using an algorithm or a processing network. In some cases, image processing software can be used for various tasks, such as image editing, image restoration, image generation, etc. Recently, machine learning models have been used in advanced image processing techniques. Among these machine learning models, diffusion models and other generative models such as generative adversarial networks (GANs) have been used for various tasks including generating images with perceptual metrics, generating images in conditional settings, image inpainting, and image manipulation.

Image generation, a subfield of image processing, includes the use of diffusion models to synthesize images. Diffusion models can be used for various image generation tasks including image super-resolution, generation of images with perceptual metrics, conditional generation (e.g., generation based on text guidance), image inpainting, and image manipulation. Specifically, diffusion models are trained to take random noise as input and generate unseen images with features similar to the training data.

### SUMMARY

The present disclosure describes systems and methods for image generation. Embodiments of the present disclosure include an image generation system configured to obtain a first image generation input (e.g., a text input indicating a scene) and a second image generation input (e.g., an image depicting an object) from a first user. An image generation model generates a first synthetic image based on the first image generation input and the second image generation input. In some examples, the first user creates an image generation template that includes a set of content creation settings. The image generation template is also referred to as a style kit. The first user selects which settings others can remix or adjust to make their own synthetic images. The first user shares the style kit with a second user. The image generation system obtains a third image generation input (e.g., an image depicting a different object) from the second user in place of the second image generation input. The image generation model generates a second synthetic image based on the first image generation input and the third image generation input.

A method, apparatus, non-transitory computer readable medium, and system for image processing are described. One or more embodiments of the method, apparatus, non-transitory computer readable medium, and system include obtaining a style kit including a first image generation input indicating a first image attribute, a second image generation input indicating a second image attribute, and a selectability parameter indicating that the second image generation input is selectable; receiving a third image generation input from a user based on the selectability parameter, wherein the third image generation input indicates a third image attribute different from the second image attribute of the second image generation input; and generating, using an image generation model, a synthetic image based on the style kit, the first image generation input, and the third image generation input, wherein the synthetic image has the first image attribute and the third image attribute.

An apparatus, system, and method for image processing are described. One or more embodiments of the apparatus, system, and method include a memory component; a processing device coupled to the memory component, the processing device configured to perform operations comprising obtaining a style kit including a first image generation input indicating a first image attribute, and a selectability parameter indicating that first image generation input is selectable; providing a user interface for replacing the first image generation input based on the selectability parameter; receiving, via the user interface, a second image generation input indicating a second image attribute different from the first image attribute; and generating, using an image generation model, a synthetic image based on the style kit and the second image generation input, wherein the synthetic image has the second image attribute.

### BRIEF DESCRIPTION OF THE DRAWINGS

FIG. 1 shows an example of an image processing system according to aspects of the present disclosure.

FIG. 2 shows an example of a method for conditional media generation according to aspects of the present disclosure.

FIG. 3 shows an example of a user interface according to aspects of the present disclosure.

FIG. 4 shows an example of style kit customization according to aspects of the present disclosure.

FIG. 5 shows an example of operating a style kit on a user interface according to aspects of the present disclosure.

FIG. 6 shows an example of a method for image generation according to aspects of the present disclosure.

FIG. 7 shows an example of an image processing apparatus according to aspects of the present disclosure.

FIG. 8 shows an example of a guided diffusion model according to aspects of the present disclosure.

FIG. 9 shows an example of a U-Net architecture according to aspects of the present disclosure.

FIG. 10 shows an example of a diffusion process according to aspects of the present disclosure.

FIGS. 11 and 12 show examples of methods for image processing according to aspects of the present disclosure.

FIG. 13 shows an example of a method for generating a style kit according to aspects of the present disclosure.

FIG. 14 shows an example of a method for modifying a style kit according to aspects of the present disclosure.

FIG. 15 shows an example of a method for training a diffusion model according to aspects of the present disclosure.

FIG. 16 shows an example of a step-by-step procedure for training a machine learning model according to aspects of the present disclosure.

FIG. 17 shows an example of a computing device for image processing according to aspects of the present disclosure.

### DETAILED DESCRIPTION

The present disclosure describes systems and methods for image generation. Embodiments of the present disclosure include an image generation system configured to obtain a first image generation input (e.g., a text input) and a second image generation input (e.g., an image depicting an object) from a first user. An image generation model generates a first synthetic image based on the first image generation input and the second image generation input. In some examples, the first user creates an image generation template that includes a set of content creation settings. The image generation template is also referred to as a style kit. The first user selects which settings others can remix or adjust to make their own synthetic images. The first user shares the style kit with a second user. The image generation system obtains a third image generation input (e.g., an image depicting a different object) from the second user in place of the second image generation input. The image generation model generates a second synthetic image based on the first image generation input and the third image generation input.

Diffusion models are a class of generative neural networks that can be trained to generate new data with features similar to features found in training data. Diffusion models can be used in image synthesis, image completion tasks, etc. In some cases, content creators want to automate content creation workflow through re-using same generative settings. A user may want to generate a synthetic image having a different foreground object than an existing object while maintaining a same style, image size, content type, etc. Conventional models fail to store generative settings and parameters as a template that can be shared with other users. Additionally, these models lack control over which settings of the image generation template others can remix or adjust to make their own synthetic images.

Embodiments of the present disclosure include an image generation system configured to obtain a first image generation input and a second image generation input from a first user; generate using an image generation model, a first synthetic image based on the first image generation input and the second image generation input; obtain a third image generation input from a second user in place of the second image generation input; and generate, using the image generation model, a second synthetic image based on the first image generation input and the third image generation input.

In some examples, the first image generation input and the second image generation input are selected from a set including a text input, a foreground input, a background input, a structure input, an image size input, a content type input, or any combination thereof. In some examples, the third image generation input comprises a same input category as the second image generation input.

In an embodiment, the image generation system stores the first image generation input and the second image generation input together as an image generation template. The image generation template is also referred to as a style kit or a generative template. In some cases, the term “Style Kits” refers to a web application that can be installed on an electronic device. Style Kits application includes a user interface that displays a set of elements, features, etc. Style Kits user interface works alongside a back-end image generator (e.g., a diffusion model) to generate on-brand images.

A style kit published from Style Kits application refers to an image generation template. The style kit relates to a permission-built-in package of files, references and assets that can be shared with other users to generate customizable content. In an example, a first user creates and saves content creation settings as a style kit named “Fantasy desert world”. The first user publishes the style kit “Fantasy desert world”. The first user is an owner of the style kit “Fantasy desert world”. The first user may choose to share the style kit with a second user by selecting which settings (and corresponding parameters) other users can remix or adjust to make their own synthetic images. One or more generation inputs/settings such as style, structure, references, model, object, and prompt are locked, so other users cannot customize the locked settings. One or more generation inputs/settings are checked by the first user, i.e., unlocked for subsequent customization.

In some examples, style kits refer to a pre-permissioned package of effects, references, and prompt(s) that can be created by a user to achieve a particular output when generating content. In some cases, the style kit can include a parameter indicating an owner of the style kit. The owner of the style kit can lock particular aspects of the style kit, which disallows other users from changing the effects, aspect ratio, model or other content the creator does not want the other users to change. In some examples, an owner of a style kit can edit the style kit once it has been published and invites collaborators (e.g., users generate content within a team) with a separate set of permissions from the owner to edit the style kit.

Some embodiments include an image generation system configured to obtain a set of image generation inputs and a selectability parameter corresponding to each of the set of image generation inputs; receive a modified input corresponding to a selectable input of the set of image generation inputs based at least in part on the selectability parameter corresponding to the selectable input; and generate, using an image generation model, a synthetic image based on the modified input and the set of image generation inputs.

Some embodiments include an image generation system configured to obtain a set of image generation inputs; receive a selectability input indicating that at least one of the set of image generation inputs is selectable; and store the set of image generation inputs together with at least one selectability parameter corresponding to the at least one of the set of image generation inputs.

The present disclosure describes systems and methods that improve on conventional image generation models by providing more efficient content generation workflow. For example, users can achieve more efficiency by sharing an image generation template (a style kit) and enabling other users to remix the style kit shared with them to make their own synthetic images. A user of an existing style kit can focus on one or more image generation inputs that need to be adjusted (e.g., an image depicting a different product other than the product in the existing style kit) while preserving other settings such as text prompt, style, etc.

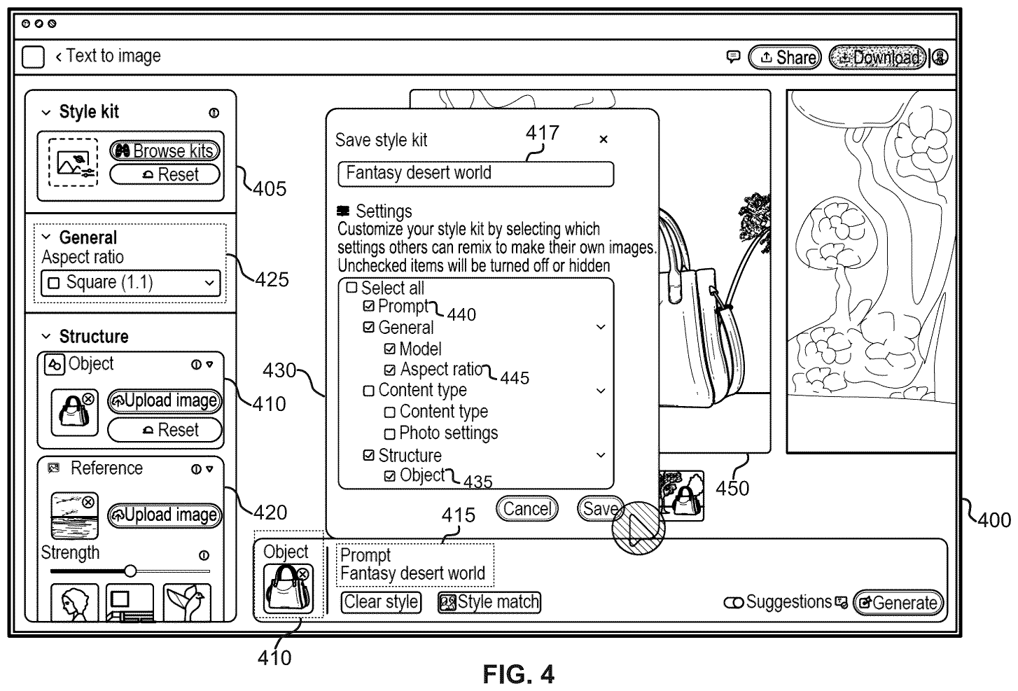

Additionally, embodiments achieve improved control over which settings related to the style kit users are permitted to adjust by receiving a selectability input indicating that at least one of a set of image generation inputs is selectable. Accordingly, an owner of a style kit has improved control over the image generation template by indicating whether an image generation input is selectable or non-selectable via a style kit user interface. In some examples, one or more image generation items may be unchecked and locked by the owner, so the locked items do not appear when other users access the style kit (refer to an example in FIG. 4).

### Image Processing

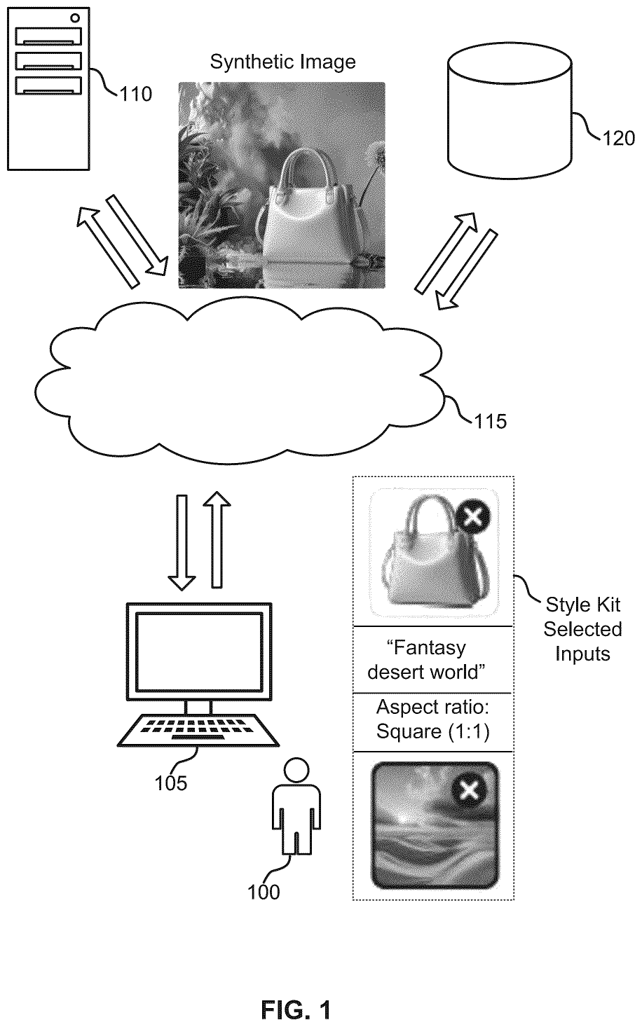

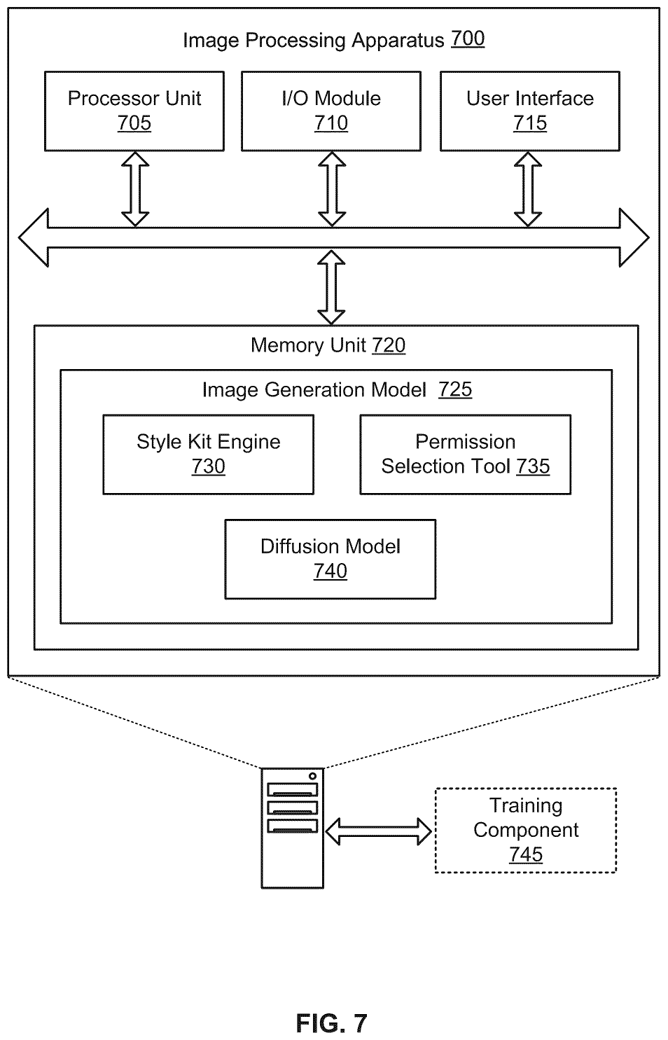

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 7.

In an example shown in FIG. 1, one or more image generation inputs for style kit are provided by user 100. The one or more image generation inputs include an image of an object (a “handbag” object), a text description (a text prompt), an aspect ratio (square, 1:1), and an example background image that the user 100 wants to use to generate a synthetic image. For example, user 100 wants the image processing apparatus 110 to generate a synthetic image of the handbag object, having a square aspect ratio and a background similar to the provided background image. This style kit is named “Fantasy Desert World”, which is also the text prompt to guide image generation. In some examples, the selected inputs of the style kit may include a text input, a foreground input, a background input, a structure input, an image size input, a content type input, or any combination thereof.

The image processing apparatus 110 receives the image generation inputs provided by the user 100 and generates a synthetic image. The image processing apparatus 110 generates, using an image generation model, a synthetic image based on the input object, the input theme, the input aspect ratio, and the input background. In this example, the synthetic image depicts the handbag object in the style consistent with text prompt “Fantasy Desert World”, having a square aspect ratio and a background similar to the provided background image. Image processing apparatus 110 returns the synthetic image to user 100 via cloud 115 and user device 105.

User device 105 may be a personal computer, laptop computer, mainframe computer, palmtop computer, personal assistant, mobile device, or any other suitable processing apparatus. In some examples, user device 105 includes software that incorporates an image processing application (e.g., an image generator, an image editing tool). In some examples, the image processing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser.

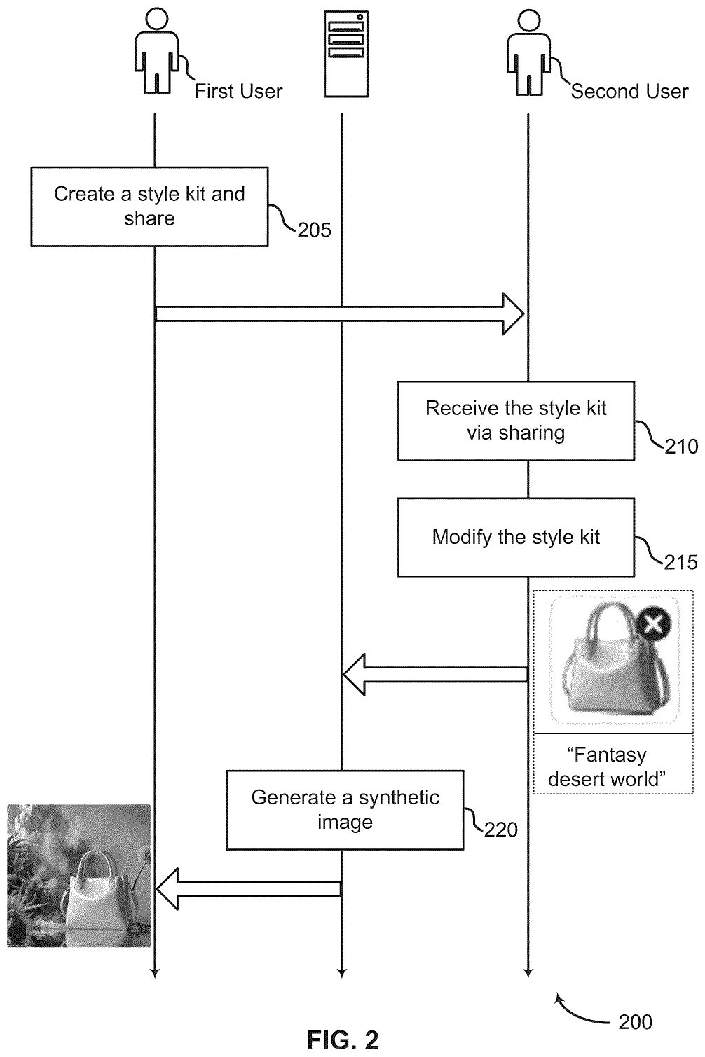

Image processing apparatus 110 includes a computer-implemented network comprising a style kit engine, a permission selection tool, and a diffusion model (such as a U-Net). Image processing apparatus 110 may also include a processor unit, a memory unit, an I/O module, and a user interface. A training component may be implemented on an apparatus other than image processing apparatus 110. The training component is used to train an image generation model (as described with reference to FIG. 7). Additionally, image processing apparatus 110 can communicate with database 120 via cloud 115. In some cases, the architecture of the image generation model is also referred to as a network or a network model. Further detail regarding the architecture of image processing apparatus 110 is provided with reference to FIGS. 7-10. Further detail regarding the operation of image processing apparatus 110 is provided with reference to FIGS. 2, 6 and 11-14.

In some cases, image processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data (e.g., dataset for training an image generation model) in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

FIG. 2 shows an example of a method 200 for conditional media generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 205, a first user creates a style kit and then the first user shares the style kit with a second user. In some cases, the operations of this step refer to, or may be performed by, a user as described with reference to FIG. 1.

In some examples, the first user locks particular aspects of the Style Kit, which disallows the second user from changing the effects, aspect ratio, model, or other content the creator does not want the other users to change. In some examples, the selected inputs of the style kit may include a text input, a foreground input, a background input, a structure input, an image size input, a content type input, or any combination thereof. In some examples, sharing the style kit includes sharing a permissioned package of reference images, product shots, aspect ratios, style presets, prompts, or any combination thereof to achieve an intended visual style for a synthetic image.

At operation 210, the second user receives the style kit via sharing. In some cases, the operations of this step refer to, or may be performed by, a user as described with reference to FIG. 1.

In some examples, the second user has access only to the aspects of the style kit that the first user gives permission to remix or adjust. In one example, the first user shared a style kit named “Fantasy desert world” which included aspects, inputs, or settings for generating a synthetic image.

At operation 215, the second user modifies the style kit. In some cases, the operations of this step refer to, or may be performed by, a user as described with reference to FIG. 1. In some examples, the second user opens a pre-existing style kit for subsequent image generation tasks.

In one example, the second user receives a style kit from the first user named “Fantasy desert world,” a package of image generation inputs or settings (e.g. content type, reference images, aspect ratios, style presets, etc.). The second user modifies the style kit based on permission settings to include an input image of a “handbag” object, while maintaining at least one of the style kit's aspects, inputs, or settings that the second user does not have permission to remix or adjust.

At operation 220, the system generates a synthetic image, using the modified style kit, based on one or more image generation inputs from the second user. In some cases, the operations of this step refer to, or may be performed by, an image processing apparatus as described with reference to FIGS. 1 and 7.

In some cases, a pre-trained image generation model generates the synthetic image based on image generation inputs in the modified style kit from the second user. The synthetic image depicts a scene according to aspects of the style kit, including the aspects, image generation inputs, or settings that the first user created, that the second user remixed or adjusted, and that the second user maintained from the style kit that was shared with them.

In the example shown in FIG. 2, the synthetic image depicts a scene of a “handbag” object in a fantasy desert world environment and background. This synthetic image is generated according to image generation inputs from the style kit modified by the second user. This includes the modification, by the second user, to include a “handbag” object, which is modifiable because of the permissions allowed and shared by the first user. The result is a synthetic image of the second user's inputted “handbag” object in the style of the “Fantasy desert world” style kit.

Some embodiments include obtaining a style kit including a first image generation input indicating a first image attribute, and a selectability parameter indicating that first image generation input is selectable; providing a user interface for replacing the first image generation input based on the selectability parameter; receiving, via the user interface, a second image generation input indicating a second image attribute different from the first image attribute; and generating, using an image generation model, a synthetic image based on the style kit and the second image generation input, wherein the synthetic image has the second image attribute.

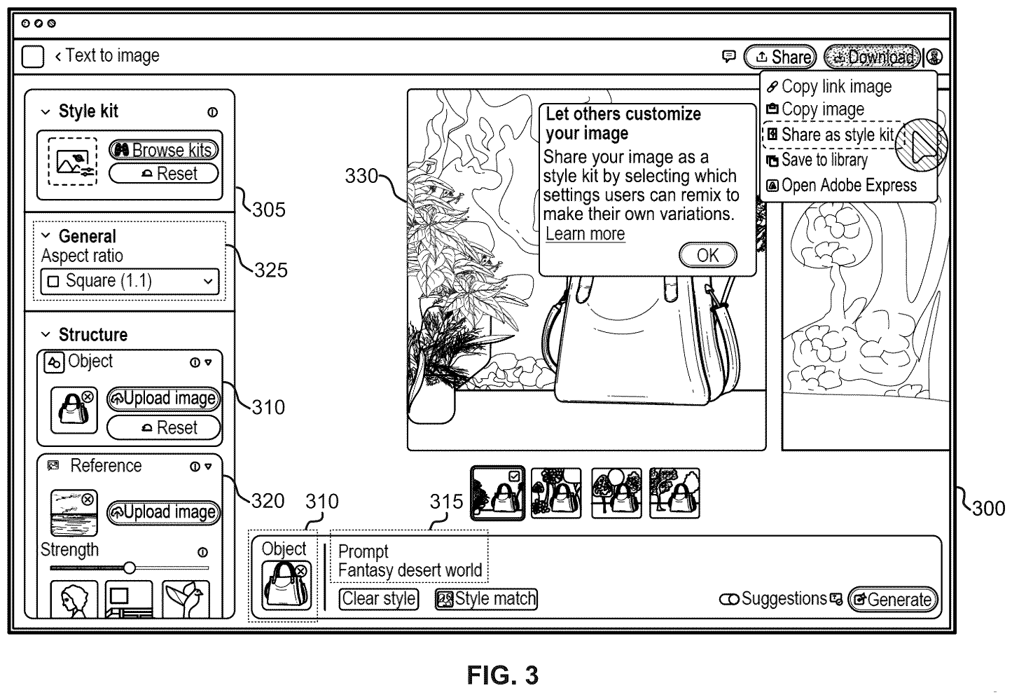

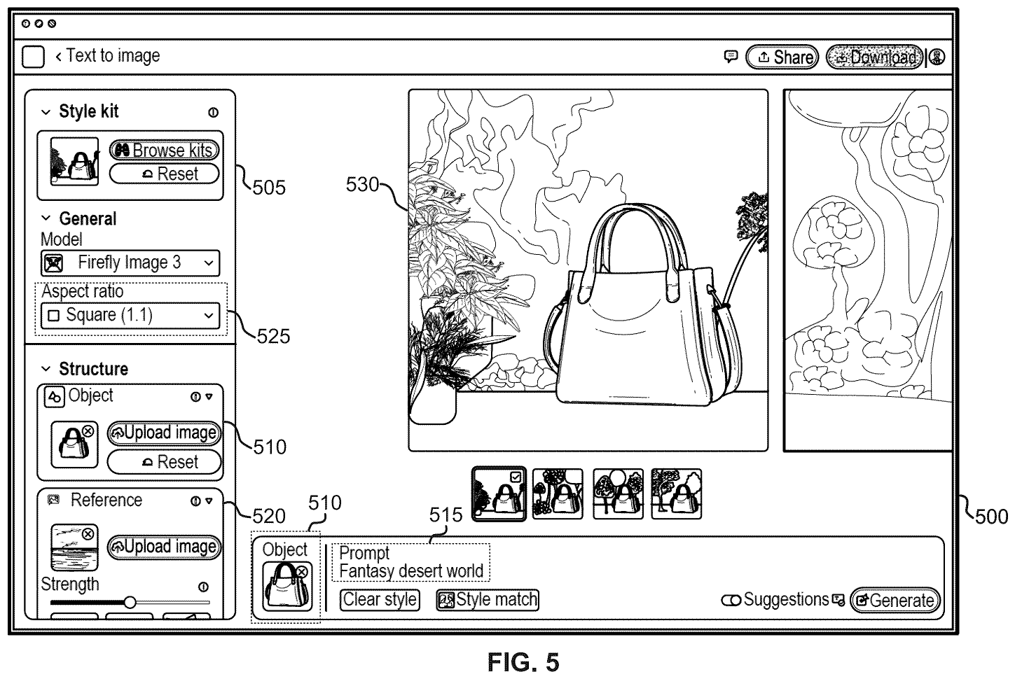

FIG. 3 shows an example of a user interface 300 according to aspects of the present disclosure. The example shown includes user interface 300, style kit customization tool 305, first image generation input 310, second image generation input 315, third image generation input 320, fourth image generation input 325, and synthetic image 330. User interface 300 is an example of, or includes aspects of, the corresponding element described with reference to FIGS. 4, 5, and 7. Style kit customization tool 305 is an example of, or includes aspects of, the corresponding element described with reference to FIGS. 4 and 5.

According to some embodiments, user interface 300 obtains, from a first user, a first image generation input 310 indicating a first image attribute, a second image generation input 315 indicating a second image attribute, and a selectability input indicating a selectability of the second image generation input 315. In some examples, user interface 300 obtains, from a second user, a third image generation input 320 based on the selectability parameter, where the third image generation input 320 indicates a third image attribute different from the second image attribute. For example, a synthetic image 330 is generated and displayed on user interface 300 by clicking “Generate” located at the bottom right area of user interface 300. The button “Generate” is clickable.

In some examples, the third image attribute has a same input category as the second image attribute. For example, an input category can include such things as “object”, “style”, “color”, etc. That is, the style kit can indicate what aspect of an input is to be included in the image. In other examples, the input category can represent an input modality such as text, image, aspect ratio, etc. In some examples, the first image generation input 310 and the second image generation input 315 correspond to different image generation input categories selected from a set of image generation input categories including a text prompt category, a foreground image category, a background image category, an image structure category, an image size category, an aspect ratio category, a content type category, a style category, or any combination thereof.

In some examples, user interface 300 receives an additional selectability input indicating a non-selectability of the first image generation input 310, where the style kit includes an additional selectability parameter corresponding to the additional selectability input. In some examples, user interface 300 receives an indication that the second image generation input 315 is selectable. The user interface 300 displays a selection element for the second image generation input 315 to the second user based on the indication. In some examples, the third image generation input 320 includes a same input category as the second image generation input 315.

In some examples, user interface 300 provides a permission selection tool to the first user. In some examples, user interface 300 receives the selectability input via the permission selection tool, where the selectability parameter is based on the selectability input. In some examples, the user interface 300 includes an element for saving the style kit and an additional element for sharing the style kit.

In an example shown in FIG. 3, a user likes a style of synthetic images and wants to save aspects of the style as a style kit customization tool 305 for marketers to use and swap in other products. From the share menu (e.g., located at top right of user interface 300), the user can view the “Share as style kit” option and its hover coach mark. By hovering on “Share as style kit” feature, a corresponding tutorial prompt shows “Let others customize your image. Share your image as a style kit by selecting which settings users can remix to make their own variations”.

In some examples, to initiate the creation of a style kit, a user accesses a central application depository (i.e., home for web applications) such as Adobe® Creative Cloud. The user selects “Style Kits” application. The central application depository provides apps, web services, and resources for creative projects, e.g., photography, graphic design, video editing, UX design, drawing and painting, social media, etc. In some examples, access points for style kits app include Creative Cloud Desktop, Adobe® Home, Adobe® content pages, notification emails, or directly on a custom website for image generation.

In some examples, for first time users, user interface 300 may display a coach mark that highlights new style kit features added to the style kit customization tool 305 and explains how to use style kit features via the style kit customization tool 305. In some cases, on the top left of the style kit customization tool 305, the “browse kits” feature is highlighted and a corresponding tutorial prompt shows “Access your style kit. You can browse and open your style kits directly in the panel or from the Files section on the Home page”.

In some examples, a user selects and applies one or more styles. An image generation model (as described with reference to image generation model 725 in FIG. 7) generates a synthetic image based on the one or more styles applied. User interface 300 guides the user towards saving and sharing as a style kit. In some examples, a coach mark highlights the “Share” button located on the top right area of user interface 300. A corresponding tutorial prompt shows “Let others customize your image. Share your image as a style kit by selecting which settings users can remix to make their own variations”.

First image generation input 310 is an example of, or includes aspects of, the corresponding element described with reference to FIGS. 4 and 5. Second image generation input 315 is an example of, or includes aspects of, the corresponding element described with reference to FIGS. 4 and 5. Third image generation input 320 is an example of, or includes aspects of, the corresponding element described with reference to FIGS. 4 and 5. Fourth image generation input 325 is an example of, or includes aspects of, the corresponding element described with reference to FIGS. 4 and 5. Synthetic image 330 is an example of, or includes aspects of, the corresponding element described with reference to FIGS. 4 and 5.

FIG. 4 shows an example of style kit customization according to aspects of the present disclosure. The example shown includes user interface 400, style kit customization tool 405, first image generation input 410, second image generation input 415, third image generation input 420, fourth image generation input 425, permission selection tool 430, first selectability input 435, second selectability input 440, third selectability input 445, and synthetic image 450. User interface 400 is an example of, or includes aspects of, the corresponding element described with reference to FIGS. 3, 5, and 7. Style kit customization tool 405 is an example of, or includes aspects of, the corresponding element described with reference to FIGS. 3 and 5.

In an embodiment, a user names the style kit by typing in the name box. For example, a name of style kit is “Fantasy desert world”. The user (e.g., style kit creator) can choose which options do or do not appear when subsequent users (e.g., content creators, style kit consumers) use the style kit. For example, a first user, via permission selection tool 430 (Settings shown), restricts the style kit to include just prompt, model, aspect ratio, and object composite as options. In some examples, the prompt, model, aspect ratio, and object are selected (i.e., check marked by the first user). Content type and photo settings are not selected. So unselected settings (unselected fields corresponding to respective image generation inputs) may not appear when subsequent users use the style kit. User interface 400 displayed the Settings menu and indicated “Customize your style kit by selecting which settings others can remix to make their own images. Unchecked items will be turned off or hidden”.

According to some embodiments, user interface 400 receives an indication that the first image generation input 410 is non-selectable. In some examples, user interface 400 refrains from displaying a selection element for the first image generation input 410 to the second user based on the indication. In some examples, user interface 400 receives an indication that the second image generation input 415 is selectable. In some examples, user interface 400 displays a selection element for the second image generation input 415 to the second user based on the indication.

According to some embodiments, user interface 400 provides a permission selection tool 430 to a user. In some examples, user interface 400 receives a selectability input via the permission selection tool 430, where the selectability parameter is based on the selectability input. Permission selection tool 430 is an example of, or includes aspects of, the corresponding element described with reference to FIG. 7. In some examples, user interface 400 provides a generative element. User interface 400 receives a generative input via the generative element. In some examples, user interface 400 initiates a generative mode based on the generative input, where the synthetic image 450 is generated based on the generative mode.

According to some embodiments, user interface 400 is configured to display the first image generation input 410, the second image generation input 415, third image generation input 420, and fourth image generation input 425. In the example shown in FIG. 4, the first image generation input 410 corresponds to an object image (target image) such as a bag. The second image generation input 415 corresponds to a text prompt such as “Fantasy desert world”. The third image generation input 420 corresponds to a reference image (e.g., style image, background image). The fourth image generation input 425 corresponds to aspect ratio (e.g., an aspect ratio is set to Square (1:1)).

In some examples, the user interface 400 includes an element for saving an image generation template. In some examples, the user interface 400 includes an element for indicating the second image generation input 415 is selectable.

In an embodiment, a user names the style kit by typing in the name box. The user (e.g., style kit creator) can choose which options do or do not appear when subsequent users (e.g., content creators, style kit consumers) use the style kit. In some cases, the user, via Settings shown on user interface 400, restricts the style kit to include just aspect ratio and object composite as options.

In some examples, once the style kit is saved, a user can copy a link or directly invite certain other user(s) to remix the style kit. Share sheet component(s) at the backend of style kit engine 730 (with reference to FIG. 7) is used to enable sharing a style kit. User interface 400 may display Share style kit menu. The user can add names or emails to grant access to a style kit. Additionally, user interface 400 can display one or more users that have access to the style kit (e.g., four users currently have access to the style kit). Alternatively, the user copies a link by clicking on “Copy link” button. Then the user pastes the link and sends it to another user. At the bottom, user interface 400 displays a message saying “‘Fantasy desert world’ saved”.

In some examples, user interface 400 displays “Invite people to view” menu. The user types in a name or an email address, includes a message (optional), and clicks “Share” button to grant access to the style kit.

A user shares a style kit with another user by adding a name or an email. The bottom of user interface 400 displays a message “Invitation sent” confirming that the invitation has been sent out to the target user. In some examples, a user receives an email and notification (e.g., app notification) that a style kit has been shared with the user. The user accesses Adobe® Firefly website and navigates to the Files tab to access and browse style kits available to the user.

First image generation input 410 is an example of, or includes aspects of, the corresponding element described with reference to FIGS. 3 and 5. Second image generation input 415 is an example of, or includes aspects of, the corresponding element described with reference to FIGS. 3 and 5. Third image generation input 420 is an example of, or includes aspects of, the corresponding element described with reference to FIGS. 3 and 5. Fourth image generation input 425 is an example of, or includes aspects of, the corresponding element described with reference to FIGS. 3 and 5. Synthetic image 450 is an example of, or includes aspects of, the corresponding element described with reference to FIGS. 3 and 5.

FIG. 5 shows an example of operating a style kit on a user interface 500 according to aspects of the present disclosure. The example shown includes user interface 500, style kit customization tool 505, first image generation input 510, second image generation input 515, third image generation input 520, fourth image generation input 525, and synthetic image 530. User interface 500 is an example of, or includes aspects of, the corresponding element described with reference to FIGS. 3, 4, and 7. Style kit customization tool 505 is an example of, or includes aspects of, the corresponding element described with reference to FIGS. 3 and 4.

In some examples, a second user (different from the first user who creates a style kit) can use or remix a style kit after the style kit has been created by using style kit customization tool 505. The second user continues working on the style kit as illustrated in FIG. 5. Changes made during remixing do not affect the style kit itself. In some cases, editing of the style kit is not permitted (i.e., a user is not permitted to edit a style kit itself). The second user can use a pre-existing style kit by providing one or more image generation inputs.

First image generation input 510 is an example of, or includes aspects of, the corresponding element described with reference to FIGS. 3 and 4. Second image generation input 515 is an example of, or includes aspects of, the corresponding element described with reference to FIGS. 3 and 4. Third image generation input 520 is an example of, or includes aspects of, the corresponding element described with reference to FIGS. 3 and 4. Fourth image generation input 525 is an example of, or includes aspects of, the corresponding element described with reference to FIGS. 3 and 4. Synthetic image 530 is an example of, or includes aspects of, the corresponding element described with reference to FIGS. 3 and 4.

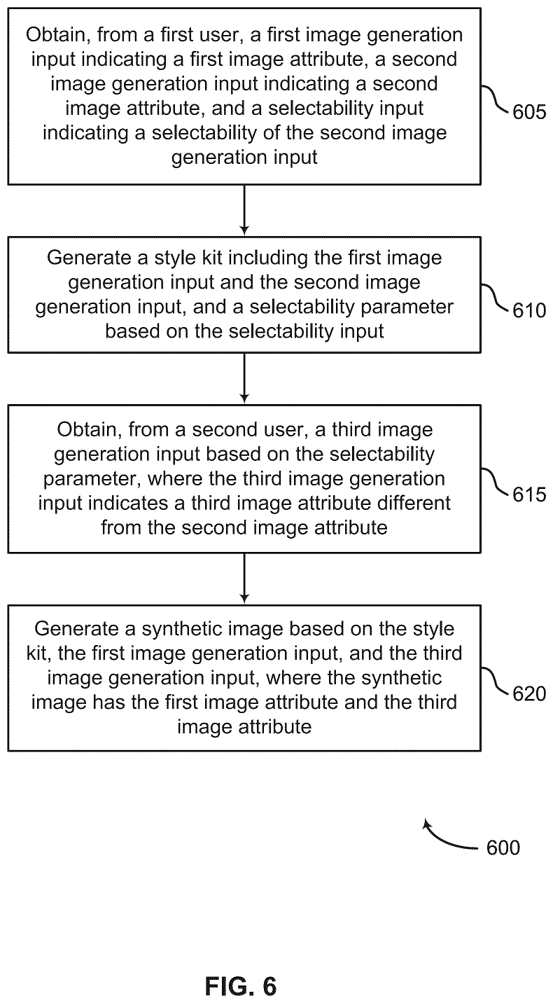

FIG. 6 shows an example of a method 600 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 605, the system obtains, from a first user, a first image generation input indicating a first image attribute, a second image generation input indicating a second image attribute, and a selectability input indicating a selectability of the second image generation input. In some cases, the operations of this step refer to, or may be performed by, a user interface as described with reference to FIGS. 3-5, and 7.

In an example, a first image generation input can be a text prompt (e.g., “fantasy desert world”) and the first image attribute can be an object or scene to be included in the image (e.g., the “desert”), as shown in FIG. 4. The second image generation input can be an input having a different modality than the first image generation input. For example, if the first image generation input is text, the second image generation input can be an image. The second image attribute can be an element in the image (such as a bag depicted in the image). The first user creates an image generation template comprising a set of image generation inputs and parameters corresponding to the set of image generation inputs. The first user can also provide a selectability input such as a checkbox indicating that some image generation inputs are selectable (i.e., they can be modified) and other image generation inputs are not selectable (i.e., not modifiable). In some examples, the set of image generation inputs and selectability parameters form the elements of a style kit.

At operation 610, the system generates a style kit including the first image generation input and the second image generation input, and a selectability parameter based on the selectability input. In some cases, the operations of this step refer to, or may be performed by, a style kit engine as described with reference to FIG. 7.

At operation 615, the system obtains, from a second user, a third image generation input based on the selectability parameter, where the third image generation input indicates a third image attribute different from the second image attribute. For example, the third image generation attribute could be an image that replaces the second image generation attribute and depicts a different object than the second image generation attribute. In some cases, the operations of this step refer to, or may be performed by, a user interface as described with reference to FIGS. 3-5, and 7. In some examples, the system transfers, by the first user, the set of image generation inputs to the second user. The second user can access the image generation template (e.g., the style kit created and saved by the first user).

In some examples, the second user modifies at least one of the set of image generation inputs to obtain a modified set of image generation inputs. The modified set of image generation inputs includes the third image generation input (e.g., an image depicting an object different from a corresponding object in the original style kit). The third image generation input is used to generate synthetic images in place of the second image generation input mentioned in operation 605.

At operation 620, the system generates, using an image generation model, a synthetic image based on the style kit and the third image generation input. The synthetic image has the first image attribute from the style kit and the third image attribute from the additional image generation input provided by the user. In some cases, the operations of this step refer to, or may be performed by, an image generation model as described with reference to FIG. 7. In some examples, the synthetic image includes the second object as a foreground object while maintaining other features originally shown in the style kit. The background, style and structure in the synthetic image is consistent with features and styles specified by the set of image generation inputs.

In an embodiment, an image generation template (e.g., a style kit) is published by the first user and then the image generation template can be edited by the first user. The first user is the creator (i.e., owner) of the style kit. The first user can invite one or more users with a separate set of permissions from the first user to edit the style kit. For example, an original style kit includes a text prompt “Fantasy desert world” and is saved and published as “Fantasy desert world template”. The style kit is edited by the first user and/or a second user to obtain an edited style kit. The edited style kit includes a modified text prompt “Fantasy water world” and is saved as “Fantasy water world template”. The default background in the edited style kit is changed to correspond to the modified text prompt “Fantasy water world”. The edited style kit can be shared with a third user for further editing or customization. Collaboration within a team of content creators is therefore improved.

In FIGS. 1-6, a method, apparatus, non-transitory computer readable medium, and system for image processing are described. One or more aspects of the method, apparatus, non-transitory computer readable medium, and system include obtaining, from a first user, a first image generation input indicating a first image attribute, a second image generation input indicating a second image attribute, and a selectability input indicating a selectability of the second image generation input; generating a style kit including the first image generation input and the second image generation input, and a selectability parameter based on the selectability input; obtaining, from a second user, a third image generation input based on the selectability parameter, wherein the third image generation input indicates a third image attribute different from the second image attribute; and generating, using an image generation model, a synthetic image based on the style kit and the third image generation input, wherein the synthetic image has the first image attribute and the third image attribute.

In some examples, the third image attribute has a same input category as the second image attribute. In some examples, the first image generation input and the second image generation input correspond to different image generation input categories selected from a set of image generation input categories comprising a text prompt category, a foreground image category, a background image category, an image structure category, an image size category, an aspect ratio category, a content type category, a style category, or any combination thereof.

Some examples of the method, apparatus, non-transitory computer readable medium, and system further include receiving an additional selectability input indicating a non-selectability of the first image generation input, wherein the style kit comprises an additional selectability parameter corresponding to the additional selectability input.

Some examples of the method, apparatus, non-transitory computer readable medium, and system further include receiving an indication that the second image generation input is selectable. Some examples further include displaying a selection element for the second image generation input to the second user based on the indication. In some examples, the third image generation input comprises a same input category as the second image generation input.

Some examples of the method, apparatus, non-transitory computer readable medium, and system further include providing a permission selection tool to the first user. Some examples further include receiving the selectability input via the permission selection tool, wherein the selectability parameter is based on the selectability input.

Some examples of the method, apparatus, non-transitory computer readable medium, and system further include obtaining a noise input. Some examples further include performing a diffusion process on the noise input.

### Network Architecture

FIG. 7 shows an example of an image processing apparatus 700 according to aspects of the present disclosure. The example shown includes image processing apparatus 700, processor unit 705, I/O module 710, user interface 715, memory unit 720, image generation model 725, and training component 745. Image processing apparatus 700 is an example of, or includes aspects of, the corresponding element described with reference to FIG. 1.

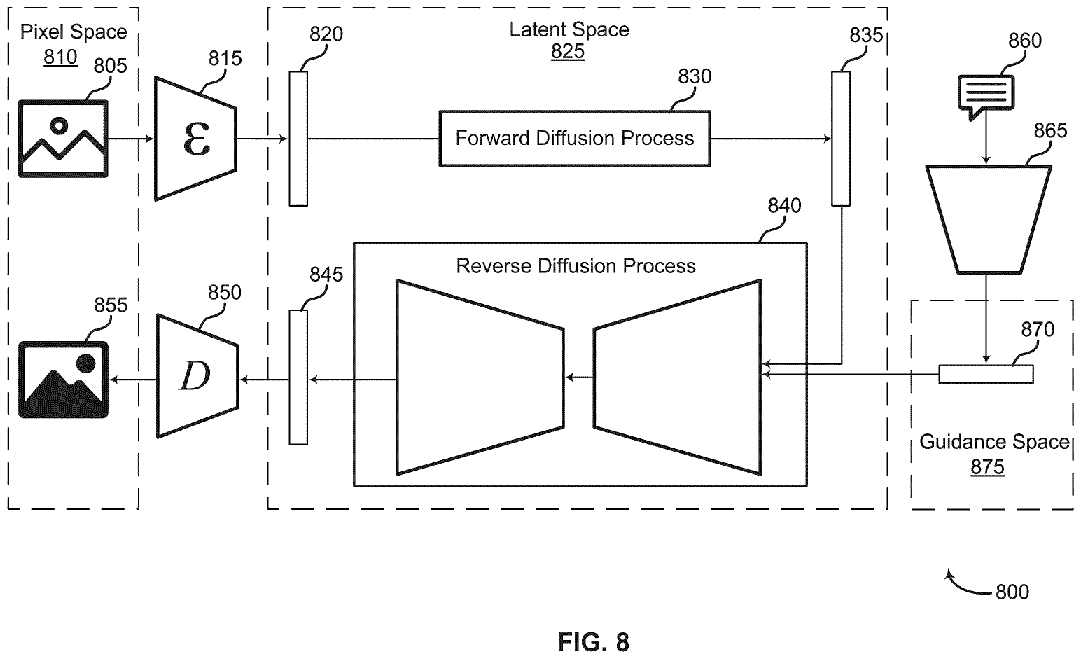

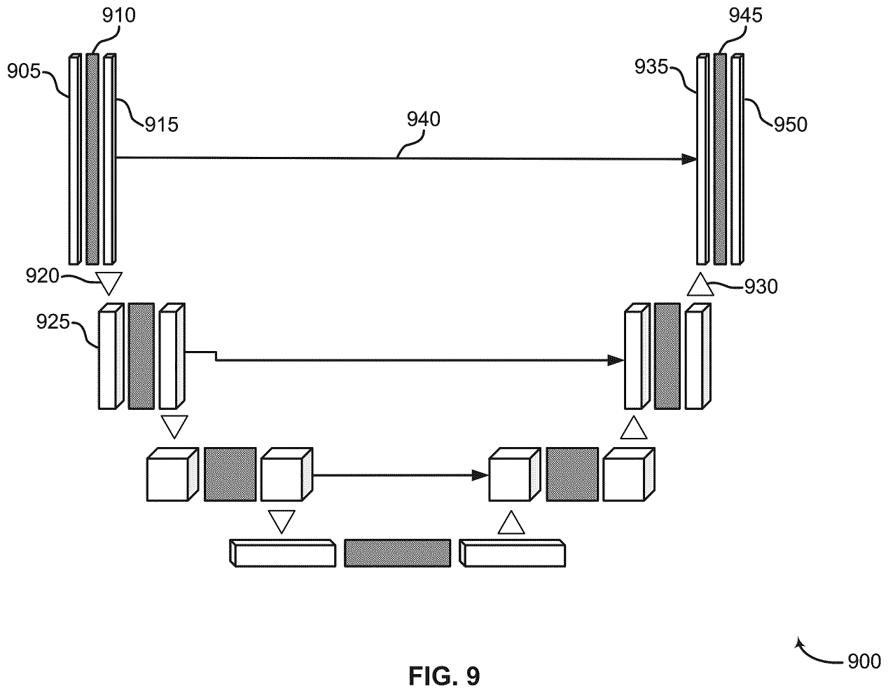

Image processing apparatus 700 may include an example of, or aspects of, the guided diffusion model described with reference to FIG. 8 and the U-Net described with reference to FIG. 9. In some embodiments, image processing apparatus 700 includes processor unit 705, I/O module 710, user interface 715, memory unit 720, image generation model 725, and training component 760. Training component 745 updates parameters of the image generation model 725 stored in memory unit 720. In some examples, the training component 745 is located outside the image processing apparatus 700.

Processor unit 705 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

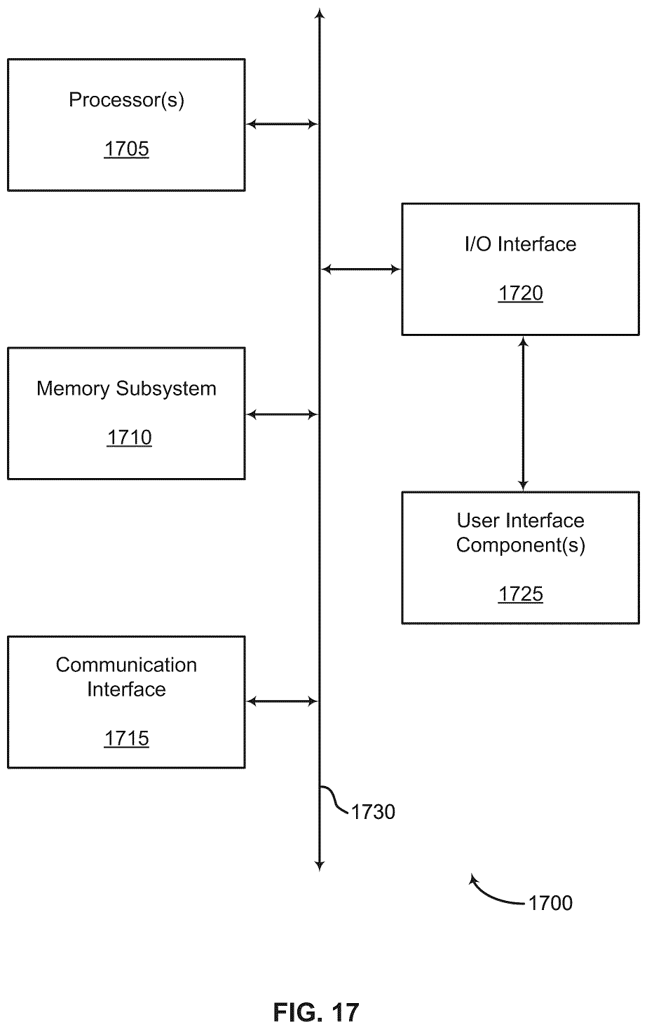

In some cases, processor unit 705 is configured to operate a memory array using a memory controller. In other cases, a memory controller is integrated into processor unit 705. In some cases, processor unit 705 is configured to execute computer-readable instructions stored in memory unit 720 to perform various functions. In some aspects, processor unit 705 includes special-purpose components for modem processing, baseband processing, digital signal processing, or transmission processing. According to some aspects, processor unit 705 comprises one or more processors described with reference to FIG. 17.

Memory unit 720 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 705 to perform various functions described herein.

In some cases, memory unit 720 includes a basic input/output system (BIOS) that controls basic hardware or software operations, such as an interaction with peripheral components or devices. In some cases, memory unit 720 includes a memory controller that operates memory cells of memory unit 720. For example, the memory controller may include a row decoder, column decoder, or both. In some cases, memory cells within memory unit 720 store information in the form of a logical state. According to some aspects, memory unit 720 is an example of the memory subsystem 1710 described with reference to FIG. 17.

According to some embodiments, image processing apparatus 700 uses one or more processors of processor unit 705 to execute instructions stored in memory unit 720 to perform functions described herein. For example, image processing apparatus 700 may obtain, from a first user, a first image generation input indicating a first image attribute, a second image generation input indicating a second image attribute, and a selectability input indicating a selectability of the second image generation input. The image processing apparatus 700 generates a style kit including the first image generation input and the second image generation input, and a selectability parameter based on the selectability input. The image processing apparatus 700 obtains, from a second user, a third image generation input based on the selectability parameter, wherein the third image generation input indicates a third image attribute different from the second image attribute. The image processing apparatus 700 generates, using an image generation model 725, a synthetic image based on the style kit and the third image generation input, where the synthetic image has the first image attribute and the third image attribute.

The memory unit 720 may include an image generation model 725 trained to obtain, from a first user, a first image generation input indicating a first image attribute, a second image generation input indicating a second image attribute, and a selectability input indicating a selectability of the second image generation input; generate a style kit including the first image generation input and the second image generation input, and a selectability parameter based on the selectability input; obtain, from a second user, a third image generation input based on the selectability parameter, wherein the third image generation input indicates a third image attribute different from the second image attribute; and generate, using image generation model 725, a synthetic image based on the style kit and the third image generation input, where the synthetic image has the first image attribute and the third image attribute. For example, after training, image generation model 725 may perform inferencing operations as described with reference to FIGS. 2, 6 and 11-14.

In some embodiments, the image generation model 725 is an artificial neural network (ANN) comprising a guided diffusion model described with reference to FIG. 8 and the U-Net described with reference to FIG. 9. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image generation model 725 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

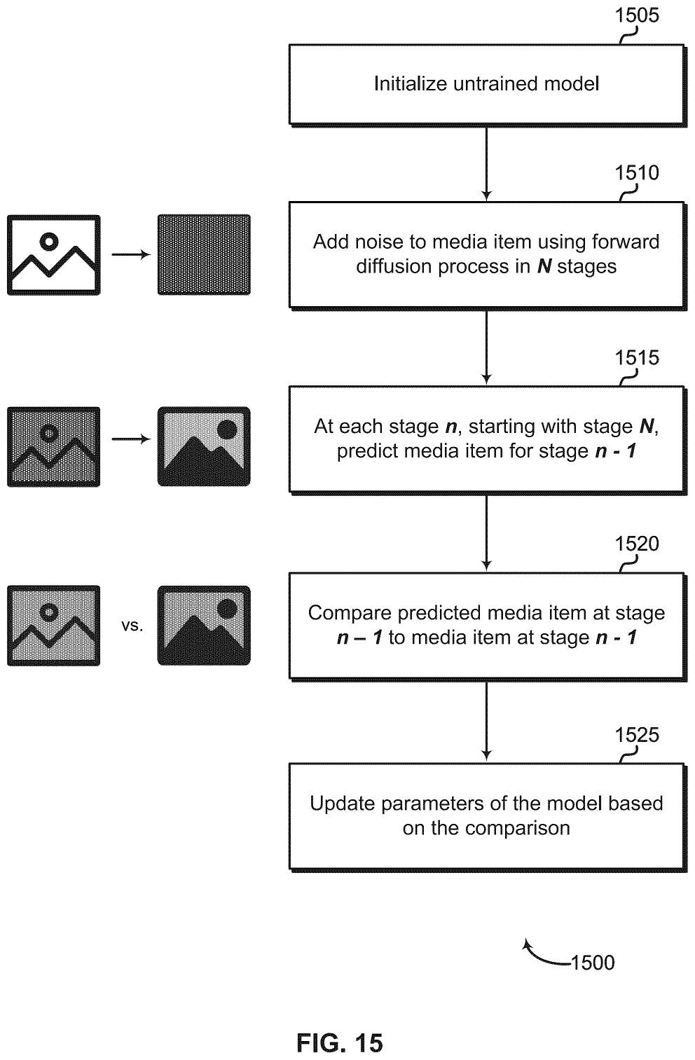

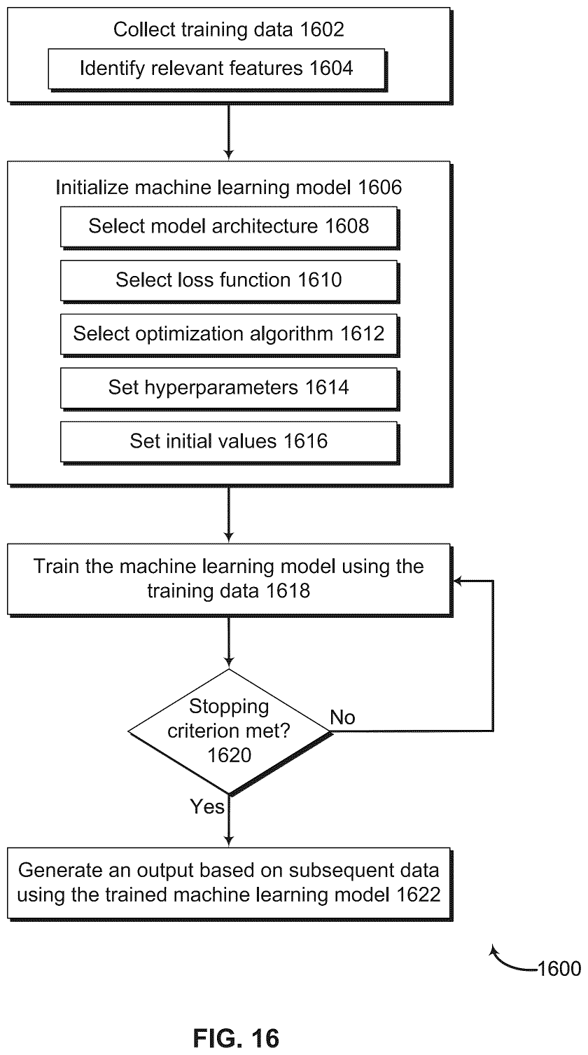

Training component 745 may train the diffusion model 740. For example, parameters of the diffusion model 740 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 15-16). The goal of the training process may be to find optimal values for the parameters that allow the machine learning model to make accurate predictions or perform well on the given task.

Accordingly, the node weights can be adjusted to increase the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 725 can be used to make predictions on new, unseen data (i.e., during inference).

I/O module 710 receives inputs from and transmits outputs of the image processing apparatus 700 to other devices or users. For example, I/O module 710 receives inputs for the image generation model 725 and transmits outputs of the image generation model 725. According to some aspects, I/O module 710 is an example of the I/O interface 1720 described with reference to FIG. 17.

In one embodiment, image generation model 725 includes style kit engine 730, permission selection tool 735, and diffusion model 740. The image generation model 725 is an example of, or includes aspects of, the corresponding element described with reference to FIGS. 8 and 9. User interface 715 is an example of, or includes aspects of, the corresponding element described with reference to FIGS. 3-5.

According to some embodiments, image generation model 725 generates, using an image generation model 725, a synthetic image based on the style kit and the third image generation input, where the synthetic image has the first image attribute and the third image attribute. In some examples, image generation model 725 obtains a noise input. The image generation model 725 performs a diffusion process on the noise input. In some examples, the image generation model 725 includes a diffusion model 740. In some examples, the image generation model 725 includes a text encoder, a style encoder, a structure encoder, or any combination thereof. In some examples, the image generation model 725 includes user interface 715 configured to display the first image generation input and the second image generation input.

According to some embodiments, style kit engine 730 generates a style kit including the first image generation input and the second image generation input, and a selectability parameter based on the selectability input.

According to some embodiments, user interface 715 provides a permission selection tool 735 to the first user. The user interface 715 receives the selectability input via the permission selection tool 735, where the selectability parameter is based on the selectability input. Permission selection tool 735 is an example of, or includes aspects of, the corresponding element described with reference to FIG. 4.

In some examples, the user browse one or more style kits available to the user. The user may filter between style kits she/he created vs. style kits that have been shared with the user. User interface 715 displays style kit “Template 1”. User interface 715 displays a style kit named “Animals in jackets”. User interface 715 displays style kit “Template 3”, style kit “Template 4”, etc.

In an embodiment, a user opens a style kit that has been shared with the user. The user sees a bespoke view of the full editor. This view, via user interface 715, displays settings the style kit allows the user to adjust. The other features of the style kit are hidden on user interface 715 (i.e., the user is not permitted to adjust). “Share style kit” option (located top right of the user interface, refer to FIGS. 3-5) is available if the user has edit or view+share access. In some cases, if the user does not have edit or view+share access, the “Share style kit” option is not available to the user (e.g., grayed out, non-clickable).

In an embodiment, a user makes changes to exposed settings. That is, the user can adjust settings that are available to the user. In some examples, an owner of the style kit selects one or more items in the Settings menu so that others can remix to make their own images. Accordingly, checked items are available to other users (refer to examples in FIGS. 3-5). In some cases, a user uploads a new image to composite. The new image includes a different product (e.g., bag). In some cases, image generation model 725 removes a background or separates the background from a foreground object. This way, the uploaded new image is transformed to a transparent image with the background removed from the foreground object. The transparent image includes the foreground object. The transparent image is then used to generate a new synthetic image based on a text prompt (e.g., “Fantasy desert world”).

In an embodiment, a new object is added in the same scale and position as an original object by default. A user can choose to adjust the scale and position from the default. For example, the user adjusts aspect ratio located on a left panel of the user interface (see FIGS. 3-5). With these settings adjusted, the user clicks on “Generate” button on the user interface. The image generation model 725 generates a synthetic image based on the new object from an uploaded image and the adjusted settings.

User interface 715 displays a synthetic image (i.e., a re-generated new image). The re-generated new image is consistent with the original image. The amount of consistency depends on the features hidden and/or adjusted. In some examples, a user can revert to the original settings to return to the initial state of the style kit. The user clicks on “Reset” button located on left panel of the user interface.

In some examples, after clicking “Reset” on left panel of user interface 2100, the original settings are reset. The user can re-generate an image by clicking “Generate” button or start adjusting settings fresh.

In an embodiment, user interface 715 enables managing one or more style kits. In the Files tab, a user browses and manages her/his style kit(s). In some examples, the user, via user interface 715, hovers over a style kit that she/he created and clicks “Delete” icon/button. The “Delete” icon is located on top-right corner. Here, the user wants to delete style kit “Template 1”. The user hovers over “Delete” icon associated with style kit “Template 1”.

In some examples, the user, via user interface 715, receives a dialog confirming whether the user wants to permanently delete the style kit. The dialog reads “if you delete the style kit, you and anyone you've shared it with will no longer have access. You cannot undo this action.” The user hovers on the “Permanently delete” button. In some examples, a thumbnail corresponding to style kit “Template 1” is grayed out and the filename is updated to display “Deleting” on user interface 715 while the style kit is being deleted.

In some examples, user interface 715 displays “Delete” operation is complete. A toast notification (or a popup message) at the bottom of user interface 715 displays that the style kit has been successfully deleted. The toast notification reads “Style kit deleted”. In some examples, if delete operation fails, user interface 715 displays an error toast notification. The error toast notification reads “Could not delete style kit”

In an embodiment, user interface 715 enables managing one or more style kits. In the Files tab, a user browses and manages her/his style kit(s). In some examples, the user, via user interface 715, hovers over a style kit that was shared with the user and clicks “Leave” icon/button. The “Leave” icon is located on top-right corner. Here, the user wants to leave style kit “Template 1”. The user hovers over the “Leave” icon associated with style kit “Template 1”. In some examples, the user, via user interface 715, receives a dialog confirming whether the user wants to leave the style kit. The dialog reads “if you leave this style kit, you will no longer have access. You cannot undo this action.” The user hovers on the “Leave” button.

In some examples, a thumbnail corresponding to style kit “Template 1” is grayed out and the filename is updated to display “Leaving” on user interface 715 while the user is removed from the style kit.

In some examples, user interface 715 displays “Leave” operation is complete. A toast notification (or a popup message) at the bottom of user interface 3000 displays that the user successfully left the style kit. The toast notification reads “You've left ‘Style kit name.’” In some examples, if leave operation fails, user interface 715 displays an error toast notification. The error toast notification reads “Could not leave style kit”.

In some examples, if a sharing link creation fails, a user receives a negative toast notification redirecting the user to try again. User interface 715 displays the toast notification at the bottom, which reads “Can't share ‘Style kit name’”. The user may click on “Try again” button located on the toast notification. In some cases, share sheet component(s) at the backend of style kit engine 730 is used to enable sharing a style kit.

In some examples, after a user clicks “Try again”, the share sheet reopens as a dialog and the share sheet is displayed again on user interface 715. The share sheet retains the names the user had previously added before the failure occurred. In some cases, share sheet component(s) is used to enable sharing a style kit.

In some examples, a user opens a link to a style kit but is not signed in. The link is shared with the user from an owner of the style kit (i.e., style kit creator). The user needs to sign in before she/he can view the style kit. In some cases, a sign in component is implemented to enable the user to sign in.

In some examples, a user is invited to a style kit. But the user has an individual plan (different from a higher tier such as an enterprise plan). The user's individual plan does not give the user access to style kit feature. When the user tries to open the style kit from an invite notification, she/he receives an error message redirecting them to a home page (e.g., Adobe® Creative Cloud Home).

In some examples, an enterprise user (different from a user having an individual plan) has access to a style kit. The enterprise user does not have access to a custom model extension used in it. As a result, the enterprise user is blocked usage of the style kit. When the enterprise user tries to open the style kit, she/he receives an error message redirecting them to a home page (e.g., Adobe® Creative Cloud Home).

In some cases, an image generation system (with reference to FIG. 1) can handle full loading error. For example, the system is not able to retrieve and load a prompt, styles, images, or style kit. When a user tries to open style kit, she/he receives an error message redirecting them to a home page.

In some cases, the system can handle partial loading error. The system is able to load a prompt, styles, and images, but not the style kit. The system blocks use of style kit because it does not know which settings are to be made visible or not visible. When the enterprise user tries to open the style kit, she/he receives an error message redirecting them to a home page.

In an embodiment, the prompt bar is locked down. That is, users who access a style kit with the prompt bar locked down would see that the prompt cannot be edited. For example, a popup message reads “prompt editing is turned off for this style kit”.

In some examples, a user (e.g., enterprise user) may have two default style kits included and displayed on user interface 715. These default style kits may be deleted. In some cases, if they are deleted, they cannot be restored. In some examples, if the user deletes the default style kits described above and does not create new ones, the style kit section displays, via user interface 715, an empty state.

FIG. 8 shows an example of a guided diffusion model according to aspects of the present disclosure. The guided latent diffusion model 800 depicted in FIG. 8 is an example of, or includes aspects of, the corresponding element (i.e., diffusion model 740) described with reference to FIG. 7.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 800 may take an original image 805 in a pixel space 810 as input and apply and image encoder 815 to convert original image 805 into original image features 820 in a latent space 825. Then, a forward diffusion process 830 gradually adds noise to the original image features 820 to obtain noisy features 835 (also in latent space 825) at various noise levels.

Next, a reverse diffusion process 840 (e.g., a U-Net ANN) gradually removes the noise from the noisy features 835 at the various noise levels to obtain denoised image features 845 in latent space 825. In some examples, the denoised image features 845 are compared to the original image features 820 at each of the various noise levels, and parameters of the reverse diffusion process 840 of the diffusion model are updated based on the comparison. Finally, an image decoder 850 decodes the denoised image features 845 to obtain an output image 855 in pixel space 810. In some cases, an output image 855 is created at each of the various noise levels. The output image 855 can be compared to the original image 805 to train the reverse diffusion process 840.

In some cases, image encoder 815 and image decoder 850 are pre-trained prior to training the reverse diffusion process 840. In some examples, image encoder 815 and image decoder 850 are trained jointly, or the image encoder 815 and image decoder 850 and fine-tuned jointly with the reverse diffusion process 840.

The reverse diffusion process 840 can also be guided based on a text prompt 860, or another guidance prompt, such as an image, a layout, a segmentation map, etc. The text prompt 860 can be encoded using a text encoder 865 (e.g., a multimodal encoder) to obtain guidance features 870 in guidance space 875. The guidance features 870 can be combined with the noisy features 835 at one or more layers of the reverse diffusion process 840 to ensure that the output image 855 includes content described by the text prompt 860. For example, guidance features 870 can be combined with the noisy features 835 using a cross-attention block within the reverse diffusion process 840.

FIG. 9 shows an example of a U-Net 900 architecture according to aspects of the present disclosure. In some examples, U-Net 900 is an example of the component that performs the reverse diffusion process 840 of guided latent diffusion model 800 described with reference to FIG. 8 and includes architectural elements of the diffusion model 740 described with reference to FIG. 7. The U-Net 900 depicted in FIG. 9 is an example of, or includes aspects of, the architecture used within the reverse diffusion process described with reference to FIG. 8.

In some examples, diffusion models are based on a neural network architecture known as a U-Net. The U-Net 900 takes input features 905 having an initial resolution and an initial number of channels and processes the input features 905 using an initial neural network layer 910 (e.g., a convolutional network layer) to produce intermediate features 915. The intermediate features 915 are then down-sampled using a down-sampling layer 920 such that down-sampled features 925 have a resolution less than the initial resolution and a number of channels greater than the initial number of channels.

This process is repeated multiple times, and then the process is reversed. That is, the down-sampled features 925 are up-sampled using up-sampling process 930 to obtain up-sampled features 935. The up-sampled features 935 can be combined with intermediate features 915 having the same resolution and number of channels via a skip connection 940. These inputs are processed using a final neural network layer 945 to produce output features 950. In some cases, the output features 950 have the same resolution as the initial resolution and the same number of channels as the initial number of channels.

In some cases, U-Net 900 takes additional input features to produce conditionally generated output. For example, the additional input features could include a vector representation of an input prompt. The additional input features can be combined with the intermediate features 915 within the neural network at one or more layers. For example, a cross-attention module can be used to combine the additional input features and the intermediate features 915.

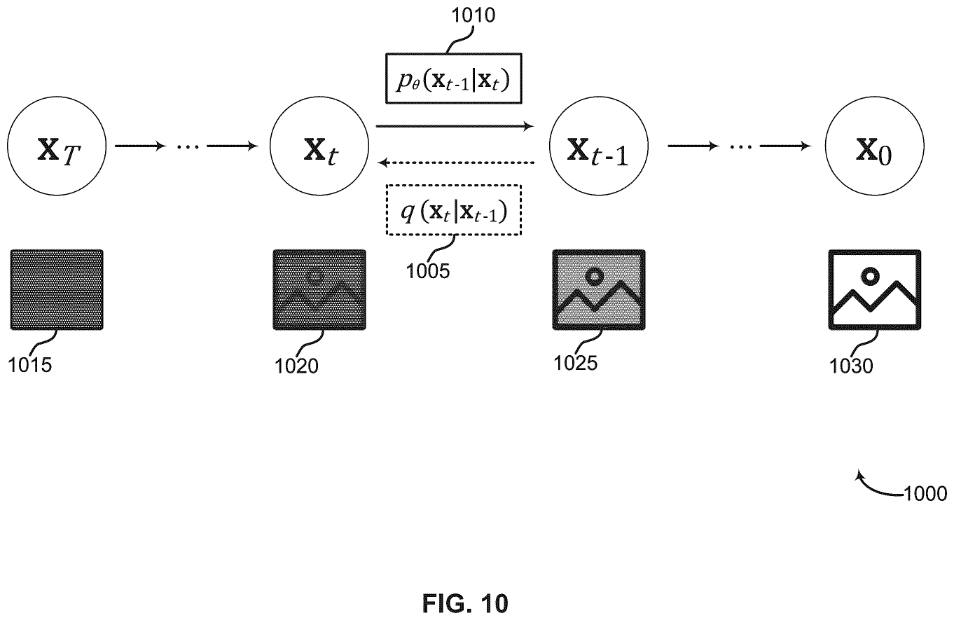

FIG. 10 shows an example of a diffusion process 1000 according to aspects of the present disclosure. In some examples, diffusion process 1000 describes an operation of the image generation model 725 described with reference to FIG. 7, such as the reverse diffusion process 840 of guided latent diffusion model 800 described with reference to FIG. 8.

As described above with reference to FIGS. 8 and 10, using a diffusion model can involve both a forward diffusion process 1005 for adding noise to a media item (or features in a latent space) and a reverse diffusion process 1010 for denoising the media item (or features) to obtain a denoised media item. The forward diffusion process 1005 can be represented as q(xₜ|xₜ₋₁), and the reverse diffusion process 1010 can be represented as p(xₜ₋₁|xₜ). In some cases, the forward diffusion process 1005 is used during training to generate media items with successively greater noise, and a neural network is trained to perform the reverse diffusion process 1010 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1010, the model begins with noisy data x_{T}, such as a noisy media item 1015 and denoises the data to obtain the p(xₜ₋₁|xₜ). At each step t−1, the reverse diffusion process 1010 takes xₜ, such as first intermediate media item 1020, and t as input. Here, t represents a step in the sequence of transitions associated with different noise levels, The reverse diffusion process 1010 outputs xₜ₋₁, such as second intermediate media item 1025 iteratively until x-reverts back to x₀, the original media item 1030. The reverse process can be represented as:

$${p}_{θ} ( {x}_{t - 1} \vert {x}_{t} ) := N ( {x}_{t - 1} ; {μ}_{θ} ( {x}_{t} , t ) , {Σ}_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N (x_{T}; 0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

In FIGS. 7-10, an apparatus, system, and method for image processing are described. One or more aspects of the apparatus, system, and method include a memory component; a processing device coupled to the memory component, the processing device configured to perform operations comprising: obtaining, from a first user, a first image generation input indicating a first image attribute, a second image generation input indicating a second image attribute, and a selectability input indicating a selectability of the second image generation input; generating a style kit including the first image generation input and the second image generation input, and a selectability parameter based on the selectability input; obtaining, from a second user, a third image generation input based on the selectability parameter, wherein the third image generation input indicates a third image attribute different from the second image attribute; and generating, using an image generation model, a synthetic image based on the style kit and the third image generation input, wherein the synthetic image has the first image attribute and the third image attribute.

In some examples, the image generation model comprises a diffusion model. In some examples, the image generation model comprises a text encoder, a style encoder, a structure encoder, or any combination thereof.

In some examples, the image generation model comprises a user interface configured to display the first image generation input and the second image generation input. In some examples, the user interface includes an element for saving the style kit and an additional element for sharing the style kit.

### Image Generation Using Style Kit

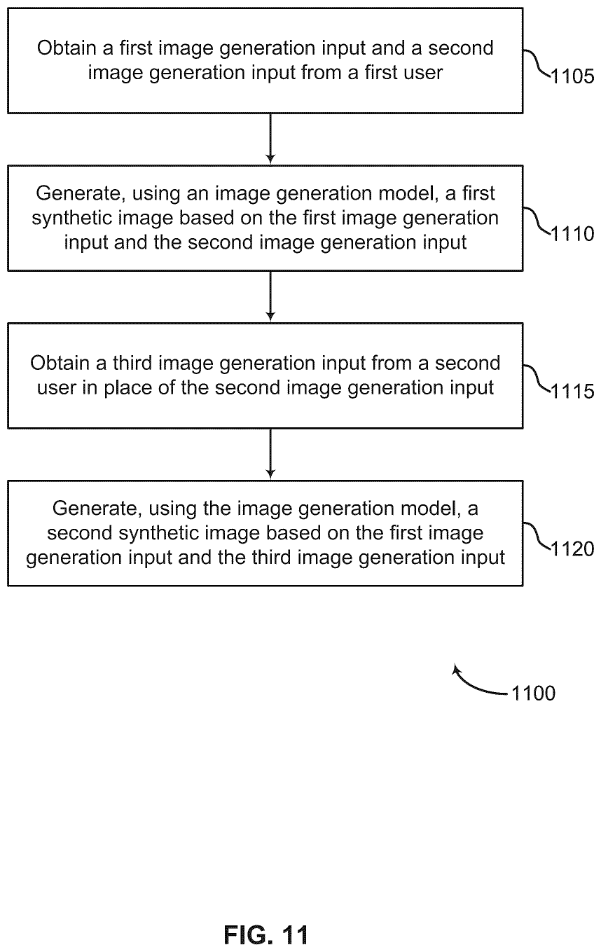

FIG. 11 shows an example of a method 1100 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1105, the system obtains a first image generation input and a second image generation input from a first user. In some cases, the operations of this step refer to, or may be performed by, a user interface as described with reference to FIGS. 3-5, and 7. In some examples, a first image generation input is a text prompt. A second image generation input is an image depicting a first object (e.g., a first product).

In some examples, the first image generation input and the second image generation input reference different categories of attributes. In one example, the first image generation input indicates an aspect ratio and the second image generation input provides a foreground object.

At operation 1110, the system generates, using an image generation model, a first synthetic image based on the first image generation input and the second image generation input. In some cases, the operations of this step refer to, or may be performed by, an image generation model as described with reference to FIG. 7.

In some examples, a pre-trained image generation model generates the synthetic image based on the first image generation input and the second image generation input. The synthetic image depicts the foreground image from the second image generation input in an aspect ratio indicated by the first image generation input.

At operation 1115, the system obtains a third image generation input from a second user in place of the second image generation input. In some cases, the operations of this step refer to, or may be performed by, a user interface as described with reference to FIGS. 3-5, and 7. In some examples, a third image generation input includes an image depicting a different object (e.g., a second product different from the first product).

In some examples, the third image generation input is within the same category as the second image generation input. The third image generation input is a different foreground object than the second image generation input.

At operation 1120, the system generates, using the image generation model, a second synthetic image based on the first image generation input and the third image generation input. In some cases, the operations of this step refer to, or may be performed by, an image generation model as described with reference to FIG. 7. In some examples, the second synthetic image includes the second product as a foreground object while maintaining other features shown in the first synthetic image. The background, style and structure in the second synthetic image are kept the same as in the first synthetic image.

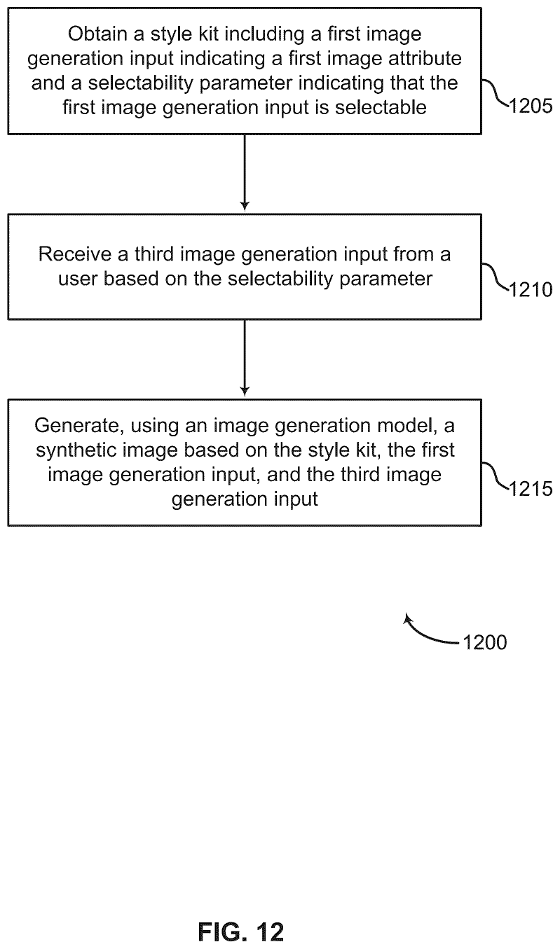

FIG. 12 shows an example of a method 1200 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1205, the system obtains a style kit including a first image generation input indicating a first image attribute, a second image generation input indicating a second image attribute, and a selectability parameter indicating that the second image generation input is selectable. In some cases, the system obtains a set of image generation inputs and a selectability parameter corresponding to each of the set of image generation inputs. In some cases, the operations of this step refer to, or may be performed by, a user interface as described with reference to FIGS. 3-5, and 7.

In some examples, the selectability parameters indicate the set of image generation inputs that a user can modify. A first image generation input is an aspect ratio, and a second image generation input is a foreground object. The second image generation input is selectable.

At operation 1210, the system receives a third image generation input from a user based on the selectability parameter, wherein the third image generation input indicates a third image attribute different from the second image attribute of the second image generation input. For example, in some cases the system receives a modified input corresponding to a selectable input of the set of image generation inputs based on the selectability parameter corresponding to the selectable input. In some cases, the operations of this step refer to, or may be performed by, a user interface as described with reference to FIGS. 3-5, and 7.

For example, the selectable second image generation input is modified to include a different foreground object. The aspect ratio of the first image generation input may not modified because it is set as not selectable.

At operation 1215, the system generates, using an image generation model, a synthetic image based on the style kit, the first image generation input, and the third image generation input, wherein the synthetic image has the first image attribute and the third image attribute. For example, using an image generation model, a synthetic image is generated based on the modified input and the set of image generation inputs. In some cases, the operations of this step refer to, or may be performed by, an image generation model as described with reference to FIG. 7.

In some examples, a pre-trained image generation model generates a synthetic image. The synthetic image depicts the modified foreground object in a scene having an aspect ratio indicated by the first image generation input.

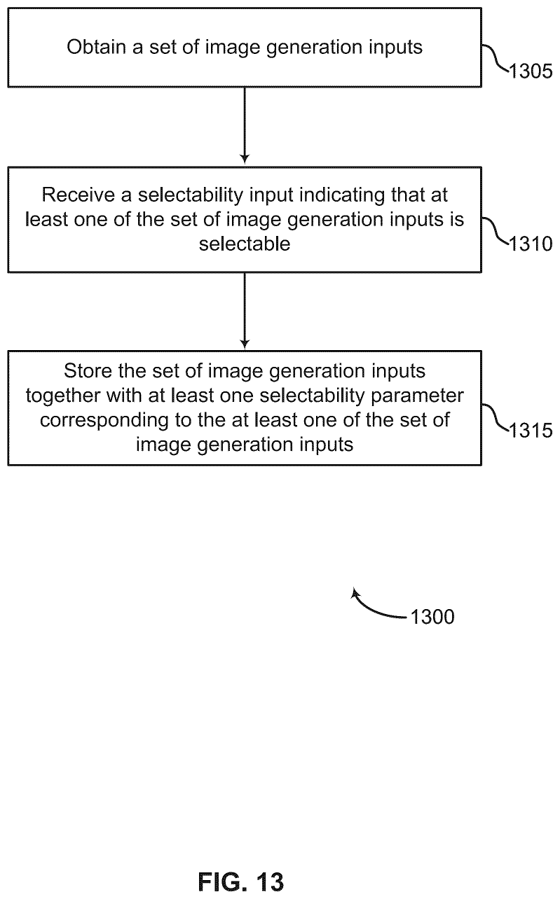

FIG. 13 shows an example of a method 1300 for generating a style kit according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1305, the system obtains a set of image generation inputs. In some cases, the operations of this step refer to, or may be performed by, a user interface as described with reference to FIGS. 3-5, and 7.

In some examples, the set of image generation inputs includes a text input, a foreground input, a background input, a structure input, an image size input, a content type input, reference images, product shots, aspect ratios, style presets, prompts, or any combination thereof.

At operation 1310, the system receives a selectability input indicating that at least one of the set of image generation inputs is selectable. In some cases, the operations of this step refer to, or may be performed by, a user interface as described with reference to FIGS. 3-5, and 7. For example, the selectability input indicates that the image size input is selectable by other users.

At operation 1315, the system stores the set of image generation inputs together with at least one selectability parameter corresponding to the at least one of the set of image generation inputs. In some cases, the operations of this step refer to, or may be performed by, a style kit engine as described with reference to FIG. 7.

For example, the set of image generation inputs is stored, including the selectability of the image size input. The stored set of image generation inputs may be referred to as the style kit.

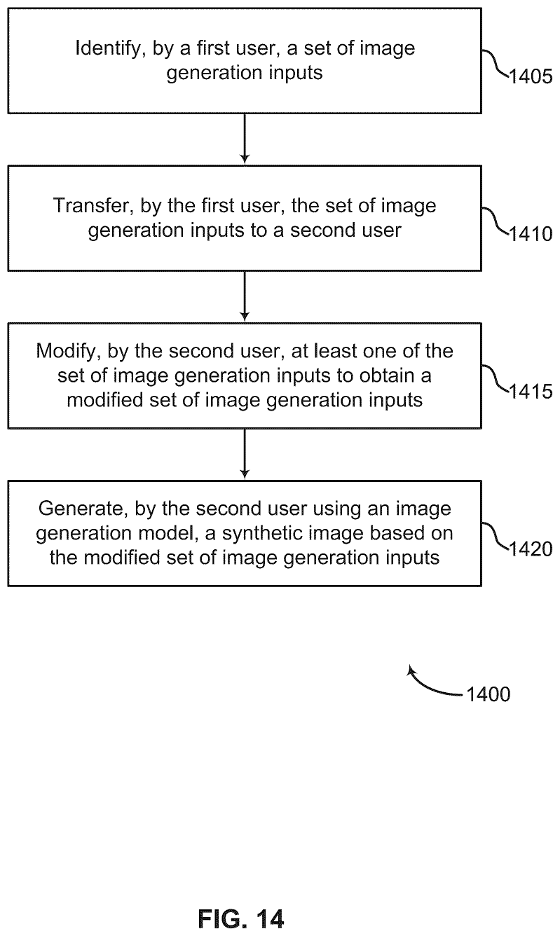

FIG. 14 shows an example of a method 1400 for modifying a style kit according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1405, the system identifies, by a first user, a set of image generation inputs. In some cases, the operations of this step refer to, or may be performed by, a user interface as described with reference to FIGS. 3-5, and 7. For example, the set of image generation inputs identified by the user includes a foreground image and an aspect ratio.

At operation 1410, the system transfers, by the first user, the set of image generation inputs to a second user. In some cases, the operations of this step refer to, or may be performed by, a style kit engine as described with reference to FIG. 7. For example, the foreground object input and the aspect ratio input (1:1) are transferred or shared with a second user.

At operation 1415, the system modifies, by the second user, at least one of the set of image generation inputs to obtain a modified set of image generation inputs. In some cases, the operations of this step refer to, or may be performed by, a user interface as described with reference to FIGS. 3-5, and 7. For example, the aspect ratio from the set of image generation inputs is modified (from a 1:1 ratio to a 1:2 ratio).

At operation 1420, the system generates, by the second user using an image generation model, a synthetic image based on the modified set of image generation inputs. In some cases, the operations of this step refer to, or may be performed by, an image generation model as described with reference to FIG. 7. For example, the synthetic image depicts the foreground object having the modified aspect ratio (1:2).

FIG. 15 shows an example of a method 1500 for training a diffusion model according to aspects of the present disclosure. In some embodiments, the method 1500 describes an operation of the training component 745 described for configuring the image generation model 725 as described with reference to FIG. 7. The method 1500 represents an example for training a reverse diffusion process as described above with reference to FIGS. 8 and 10. In some examples, these operations are performed by a system including a processor executing a set of codes to control functional elements of an apparatus, such as the guided latent diffusion model described in FIG. 8.

Additionally or alternatively, certain processes of method 1500 may be performed using special-purpose hardware. Generally, these operations are performed according to the methods and processes described in accordance with aspects of the present disclosure. In some cases, the operations described herein are composed of various substeps or are performed in conjunction with other operations.

At operation 1505, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1510, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1515, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1520, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1525, the system updates parameters of the model based on the comparison. For example, parameters of a U-Net may be updated using gradient descent. Time-dependent parameters of the Gaussian transitions can also be learned.

FIG. 16 shows an example of a step-by-step procedure 1600 for training a machine learning model according to aspects of the present disclosure. FIG. 16 shows a flow diagram depicting an algorithm as a step-by-step procedure 1600 in an example implementation of operations performable for training a machine-learning model. In some embodiments, the procedure 1600 describes an operation of the training component 745 described for configuring the image generation model 725 as described with reference to FIG. 7. The procedure 1600 provides one or more examples of generating training data, use of the training data to train a machine learning model, and use of the trained machine learning model to perform a task.

To begin in this example, a machine-learning system collects training data (block 1602) to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1604) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1606). Initialization of the machine-learning model includes selecting a model architecture (block 1608) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1610). The loss function is utilized to measure a difference between an output of the machine-learning model (i.e., predictions) and target values (e.g., as expressed by the training data) to be used to train the machine-learning model. Additionally, an optimization algorithm is selected (1612) to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1614) examples of which includes initializing weights and biases of nodes to increase efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1618) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1620), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1620), the procedure 1600 continues training of the machine-learning model using the training data (block 1618) in this example.

If the stopping criterion is met (“yes” from decision block 1620), the trained machine-learning model is then utilized to generate an output based on subsequent data (block 1622). The trained machine-learning model, for instance, is trained to perform a task as described above and therefore, once trained is configured to perform that task based on subsequent data received as an input and processed by the machine-learning model.

FIG. 17 shows an example of a computing device 1700 for image processing according to aspects of the present disclosure. The computing device 1700 may be an example of the image processing apparatus 700 described with reference to FIG. 7. In one aspect, computing device 1700 includes processor(s) 1705, memory subsystem 1710, communication interface 1715, I/O interface 1720, user interface component(s) 1725, and channel 1730.

In some embodiments, computing device 1700 is an example of, or includes aspects of, the image generation model 725 of FIG. 7. In some embodiments, computing device 1700 includes one or more processors 1705 that can execute instructions stored in memory subsystem 1710 to perform media generation.

According to some aspects, computing device 1700 includes one or more processors 1705. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special-purpose components for modem processing, baseband processing, digital signal processing, or transmission processing.

According to some aspects, memory subsystem 1710 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1715 operates at a boundary between communicating entities (such as computing device 1700, one or more user devices, a cloud, and one or more databases) and channel 1730 and can record and process communications. In some cases, communication interface 1715 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1720 is controlled by an I/O controller to manage input and output signals for computing device 1700. In some cases, I/O interface 1720 manages peripherals not integrated into computing device 1700. In some cases, I/O interface 1720 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1720 or via hardware components controlled by the I/O controller.

According to some aspects, user interface component(s) 1725 enable a user to interact with computing device 1700. In some cases, user interface component(s) 1725 include an audio device, such as an external speaker system, an external display device such as a display screen, an input device (e.g., a remote-control device interfaced with a user interface directly or through the I/O controller), or a combination thereof. In some cases, user interface component(s) 1725 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
receiving, by a user, a style kit including a first image generation input indicating a first image attribute, a second image generation input indicating a second image attribute, and a selectability parameter indicating that the second image generation input is selectable;
receiving a third image generation input from the user based on the selectability parameter, wherein the third image generation input indicates a third image attribute different from the second image attribute of the second image generation input; and
generating, using an image generation model, a synthetic image based on the style kit, the first image generation input, and the third image generation input, wherein the synthetic image has the first image attribute and the third image attribute.

2. The method of claim 1, further comprising:
receiving, by another user, the first image generation input, the second image generation input, and a selectability input indicating the selectability of the second image generation input; and
generating, by the another user, the style kit based on the first image generation input, the second image generation input, and the selectability input.

3. The method of claim 2, further comprising:
providing a permission selection tool; and
receiving the selectability input via the permission selection tool, wherein the selectability parameter is based on the selectability input.

4. The method of claim 2, further comprising:
receiving an additional selectability input indicating a non-selectability of the first image generation input, wherein the style kit comprises an additional selectability parameter corresponding to the additional selectability input.

5. The method of claim 1, wherein:
the first image generation input and the second image generation input correspond to different image generation input categories selected from a set of image generation input categories comprising a text prompt category, a foreground image category, a background image category, an image structure category, an image size category, an aspect ratio category, a content type category, a style category, or any combination thereof.

6. The method of claim 1, further comprising:
displaying a selection element for the second image generation input based on the selectability parameter.

7. The method of claim 1, wherein:
the third image generation input comprises a same image generation input category as the second image generation input.

8. The method of claim 1, wherein generating the synthetic image comprises:
obtaining a noise input; and
performing a diffusion process on the noise input.

9. A non-transitory computer readable medium storing code for image processing, the code comprising instructions that, when executed by at least one processor, cause the at least one processor to perform operations comprising:
obtaining a style kit including a first image generation input indicating a first image attribute and a selectability parameter indicating that the first image generation input is selectable;
providing a user interface for replacing the first image generation input based on the selectability parameter;
receiving, via the user interface, a second image generation input indicating a second image attribute different from the first image attribute; and
generating, using an image generation model, a synthetic image based on the style kit and the second image generation input, wherein the synthetic image has the second image attribute.

10. The non-transitory computer readable medium of claim 9, wherein:
the second image generation input has a same image generation input category as the first image generation input.

11. The non-transitory computer readable medium of claim 9, wherein:
the first image generation input and the second image generation input correspond to different image generation input categories selected from a set of image generation input categories comprising a text prompt category, a foreground image category, a background image category, an image structure category, an image size category, an aspect ratio category, a content type category, a style category, or any combination thereof.

12. The non-transitory computer readable medium of claim 9, wherein:
obtaining the first image generation input and a selectability input indicating the selectability of the first image generation input; and
generating the style kit based on the first image generation input and the selectability input.

13. The non-transitory computer readable medium of claim 9, wherein providing the user interface comprises:
displaying a selection element corresponding to the first image generation input.

14. The non-transitory computer readable medium of claim 9, wherein:
the user interface displays a plurality of image generation inputs, and wherein a subset of the plurality of image generation inputs is selectable.

15. The non-transitory computer readable medium of claim 9, the code further comprising instructions executable by the at least one processor to perform operations comprising:
providing a permission selection tool; and
receiving a selectability input via the permission selection tool, wherein the selectability parameter is based on the selectability input.

16. A system comprising:
a memory component; and
a processing device coupled to the memory component, the processing device configured to perform operations comprising:
obtaining a style kit including a first image generation input indicating a first image attribute, a second image generation input indicating a second image attribute, and a selectability parameter indicating that the second image generation input is selectable;
receiving a third image generation input from a user based on the selectability parameter, wherein the third image generation input indicates a third image attribute different from the second image attribute of the second image generation input; and
generating, using an image generation model, a synthetic image based on the style kit, the first image generation input, and the third image generation input, wherein the synthetic image has the first image attribute and the third image attribute.

17. The system of claim 16, wherein:
the image generation model comprises a diffusion model.

18. The system of claim 16, wherein:
the image generation model comprises a text encoder, a style encoder, a structure encoder, or any combination thereof.

19. The system of claim 16, wherein:
the system comprises a user interface configured to display the first image generation input and the second image generation input.

20. The system of claim 19, wherein:
the user interface includes an element for saving the style kit and an additional element for sharing the style kit.
